(19) United States
(12) Patent Application Publication
(10) Pub. No.: US 2011/0167992 A1
(43) Pub. Date: Jul. 14, 2011

(54) Method and Apparatus for Multi-Touch Sensing

(75) Inventors: Franklin N. Eventoff, Bow, WA (US); Veronica Merryfield, Port Alberni (CA)

(73) Assignee: Sensitronics, LLC

(21) Appl. No.: 13/005,495

(22) Filed: Jan. 12, 2011

Related U.S. Application Data
(60) Provisional application No. 61/294,405, filed on Jan. 12, 2010.

(51) Int. Cl. G10H 3/00

(52) U.S. Cl. 84/723

(57) ABSTRACT

The method and apparatus for multi-touch sensing is capable of detecting multiple musical instrument inputs and gestures. For example, a hand drummer may play with multiple fingers on one hand while using the heel of the palm of the other hand to slide across the drumming surface increasing the force on the head and modify the pitch of the drum. The method and apparatus for multi-touch sensing simulates conventional drum playing surfaces using multi-entry input and enables the gestural features of conventional drum playing surfaces.

### RELATED APPLICATIONS

This application claims priority from copending U.S. Provisional Patent Application 61/294,405 filed Jan. 12, 2010.

### FIELD OF THE INVENTION

The present invention relates generally to the field of analog input sensors and more specifically to the field of input sensors for electronic musical instruments.

### BACKGROUND OF THE INVENTIONS

Modern musical instruments are integrating electronic sensors to detect musician inputs. For example, typical drum controllers employ piezo-electric sensors in or on each drum surface with one input per drum playing surface. An improvement has led to multi-entry electronic drum devices using the same discrete sensor in two or more surface location zones to achieve multi-entry.

### SUMMARY

The method and apparatus for multi-touch sensing is capable of detecting multiple musical instrument inputs and gestures. For example, a hand drummer may play with multiple fingers on one hand while using the heel of the palm of the other hand to slide across the drumming surface increasing the force on the head and modify the pitch of the drum. The method and apparatus for multi-touch sensing simulates conventional drum playing surfaces using multi-entry input and enables the gestural features of conventional drum playing surfaces.

The method and apparatus for multi-touch sensing employs force sensing resistors in a shunt mode configuration to measure not only the location of simultaneously applied forces but the intensity of multiple applied forces on an electronic drum playing surface.

These and other features and advantages will become further apparent from the detailed description and accompanying figures that follow. In the figures and description, numerals indicate the various features of the disclosure, like numerals referring to like features throughout both the drawings and the description.

### BRIEF DESCRIPTION OF THE DRAWINGS

FIG. 1 is a schematic of a shunt mode multi-touch sensor.

FIG. 2 is a schematic for multiple shunt mode multi-touch sensors.

FIG. 3 is a layout diagram for the membrane traces for a shunt mode multi-touch sensor.

FIG. 4 is a perspective view of the FSR sensor layers deposited on a multilayer drumhead.

FIG. 5 is a closeup view of the edge of the concentric interdigiting layer and tail traces of the FSR sensor of FIG. 4 taken along C-C.

FIG. 6 is a closeup view of the center of the concentric interdigiting layer of FIG. 4.

FIG. 7 is a closeup view of two traces from FIG. 3 illustrating the elements for circuit analysis.

FIG. 8 is schematic diagram used for circuit analysis of multiple touches of the traces of FIG. 7.

FIG. 9 is a schematic of a shunt mode multi-touch sensor

### DETAILED DESCRIPTION OF THE INVENTIONS

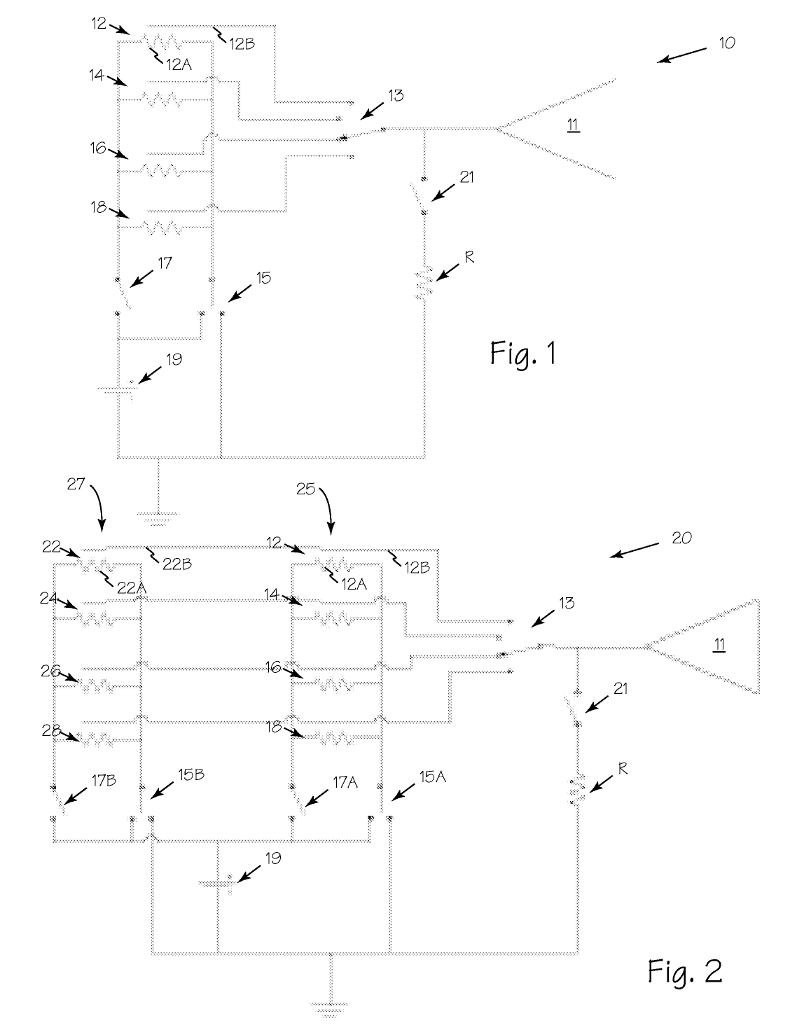

Referring now to FIG. 1, multi-touch sensor 10 includes one or more force sensing resistor assemblies such as FSR assemblies 12, 14, 16 and 18. Each FSR assembly is made up of a force sensing resistor such as FSR 12A and a resistance trace such as trace 12B. Multiplexer 13 provides a method to read the resistance traces on each of the FSR assembly in turn. Multiplexer 15 provides a voltage source to one end of each force sensing assembly with the other ends connected to positive voltage reference 21. For each position of multiplexer 13, multiplexer 15 is placed in the first then the second position to make two readings of each force sensor assembly. Switch 21 switches in reference resistor R as part of the measuring. Switch 17 is needed to isolate each group. If a touch in this group is concurrent with a touch in another group, this touch would adversely affect readings in another group with the multiplexer 13 inputs connected together.

Measurements are taken in two stages. The first measurement is used to find the location on the trace, the second is to determine the force applied to the force sensor assembly.

The first measurement for each position of 13 is made by setting switch 21 to off so resistor R is not connected to the measurement circuit and multiplexer 15 will be at a potential of zero volts. The trace resistance is now a potential divider with the FSR as a wiper. Since resistor R is out of circuit, the FSR resistances will have no effect other than to limit the current source. However, at low force, this is around 500K which is too high as an input impedance to the analog converter which means an input op-amp will be required. The trace resistance is approximately 10 ohms per inch. A 10 inch trace is therefore 100 ohms. The voltage applied across the traces must be kept low to avoid burning out the trace. However, the voltage will only be applied for relatively short duty cycles which should mitigate the issue.

The second measurement is made by putting multiplexer 15 to the positive voltage and closing switch 21. The trace resistance being low and with the same positive voltage on each end of the trace effectively eliminates the trace resistance. The FSR is now in circuit with resistor R as a potential divider thus the analog input is now able to measure just the force ratio-metrically with resistor R.

The microprocessor system is thus able to scan to look for the points of contact only. Once a contact has been located, it can then measure the force at that location.

In this system, multiplexer 13 is the input multiplexer in the PIC, multiplexer 15 will be digital outputs, switch 21 will be FET switches and resistor R with be reference resistors. With multiplexer 13 in the PIC, a number of external FET op-amps are also required.

This system can be extended to detect two points of contact. Both multiplexer 15 and switch 17 are able to alternatively select a positive or negative reference voltage or be open circuit. By selecting one end of the resistor and measuring, then the other end, two touches can be detected.

Referring now to FIG. 2, multi-touch sensor 20 can be extended to detect two points of contact, one contact in each set of detectors such as detector set 25 and detector set 27. Both multiplexers 15A and 15B and switches 17A and 17B are able to alternatively select a positive or negative reference or be open circuit. By selecting one end of the resistor and measuring, then the other end, two touches can be detected.

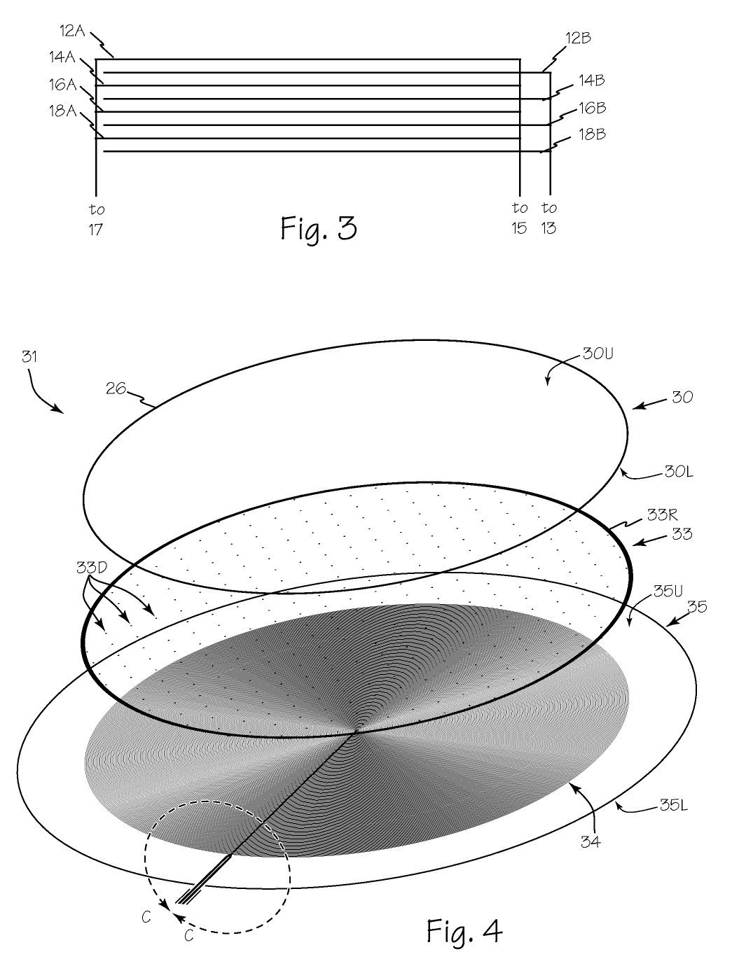

FIG. 3 illustrates the force sensing resistors and traces such as force sensor assembly 12, 14, 16 and 18 as in FIGS. 1 and 2. First end 28 of force sensing resistors 12A, 14A, 16a and 18A are connected together which will be connected to the positive reference voltage through switch 17. Second ends 29 are connect to multiplexer 15. Resistance traces 12B, 14B, 16B and 18B are connected to multiplexer 13. The wiper traces and end connectors are conductive. This pattern is laid out across the entire sensing surface.

A software system scans the Resistance traces, trace by trace, searching for a point of contact. With knowledge of the geometry of the sensor layout, the software is able to determine the point of contact and the dynamics of the applied pressure both in terms of pressure changes and position changes. The position is used to access a lookup table in order to configure the output which is then sent using MIDI, USB or other suitable transport.

The look up table in this instance would provide a position to MIDI note conversion with pressure and dynamics being assigned to velocity, control codes and aftertouch, for instance. However, the output translation is not limited to either MIDI or note number, but is rather able to be anything with meaning to the receiving system.

The sensor can be divided into a number of regions with each region having different interpretation. Such regions can either be fixed during production or edited by the user. Region editing is facilitated through host (PC, Mac) software for which the sensor becomes a USB HID (Human Input Device) i.e. the sensor appears as a mouse pad to the host allowing the user to make gestures on the sensor whilst the host displays a mimic on screen.

The regionization can then changed dynamically with set changes as is the norm with MIDI setups.

Referring now to FIG. 4, the layers of a force sensing resistor such as FSR 12 are illustrated separately for clarity. FSR 12 may be in a multilayer drumhead such as drumhead 31. First layer 30 of an instrument such as drumhead 31 has an upper surface 30U and an opposing lower surface called contact surface 30C. Contact surface 30C includes resistor layer 32 deposited to define playing zone 26. Playing zone 26 may include one or more resistor zones as discussed above. Dielectric layer 33 is a planar arrangement of non-conductive elements such as spacer ring 33R and a plurality of separating elements such as dots 33D. The separating elements may adopt any suitable size and shape. The non-conductive elements of dielectric layer 33 such as spacer ring 33R and dots 33D may be deposited on resistor layer 32 or resistor traces 34. Second layer 35 has a lower surface 35L and an opposing upper surface called contact surface 35C. Second layer contact surface 35C includes one or more sets of interdigiting fingers or resistor traces 34 such as fingers deposited to form one or more sensing zones corresponding to resistor zones as described above. Resistor traces 34 may adopt several configurations such as spiral or concentric layouts.

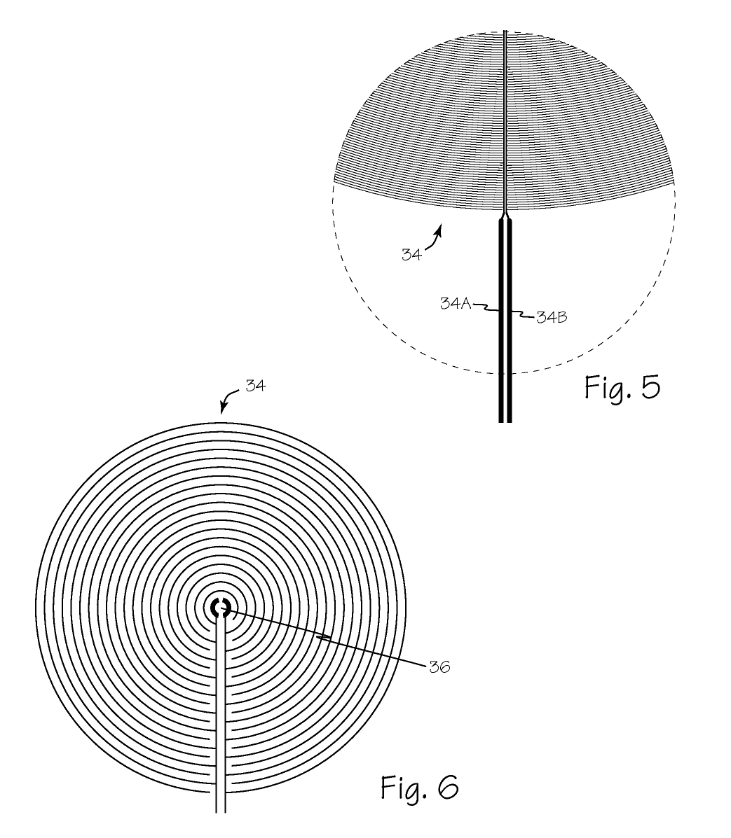

Referring now to FIGS. 5 and 6, interdigiting elements of resistor traces 34 are illustrated in a concentric configuration with first and second connector traces 34A and 34B and center trace 36. If a spiral design is used, the firmware can detect position anywhere on the head within the spiral. This also is a single entry device detecting one strike at a time. The spiral design can also be designed with a discrete “rim zone” sensor to change the strike on the body of the head with additional dynamics when the rim-zone is simultaneously or otherwise struck.

In use as a single zone drumhead, first layer 30 is superimposed over second layer 35 and is oriented with first layer contact surface 30C facing second layer contact surface 35C. With a drumhead formed with this orientation, a multilayer drumhead may be played by a musician as an acoustic drum or an electronic drum by striking upper surface 30U of first layer 30 within playing zone 26.

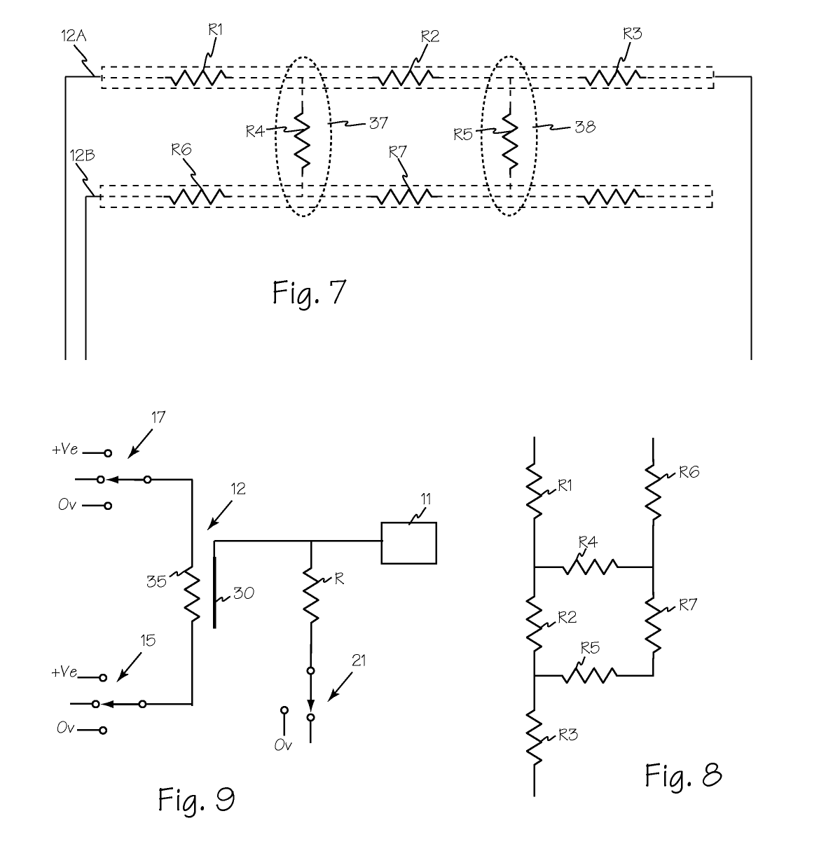

Resistive trace layers such as second layer 35 are constructed as pairs of resistive traces such as traces 12A and 12B which is in apposition to a resistive layer, first layer 30 separated by dielectric spacers as discussed above. Referring now to FIGS. 7, 8 and 9, when a touch is made such as first touch 37, a resistive circuit is created. First touch 37 forms resistor R4 between traces 12A and 12B. For a single touch, the position of the touch can be determined from the calculated value of resistors R1 and R6 while the pressure is calculated from the value of R4. For two or more touches such as first touch 37 and second touch 38, the positions are determined from the value of resistors R1, R2, R3, R6 and R7 while the pressures are from the values of R4 and R5.

Thus the equivalent circuit is shown in FIG. 8. Using just a single analog to digital converter, ADC 11, channel per sensing element such as FSR assembly 12, digital switches 15 and 17 are used to turn on, off or open circuit FSR 12 while another digital switch, switch 21 grounds or open circuits reference resistor R. By using various combinations, ADC 11 can read the voltages for each combination. Using these readings and the pre-calculated simultaneous equations derived from Kirchoff circuit analysis or by using state variable computation, the resistance values can be determined which leads to two positions and pressures values.

Multiple measurements from number of combinations and processed according to a set of linear equations for those combinations thus resolving the 5 distinct resistor values and therefore two positions and two force values. This approach may also be used for more than two simultaneous FSR touches.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. An apparatus for sensing the location and force of multiple simultaneous touches comprising:
a force sensing resistor having a resistive layer in apposition to a trace layer with parallel interdigiting traces having a first and second output connections;
a reference resistor connected to the force sensing resistor;
a first digital switch connected to the force sensing resistor;
a second digital switch connected to the force sensing resistor; and
an analog to digital converter connected to the junction of the reference resistor and the force sensing resistor for producing an output corresponding to the number and force of touches sensed by the force sensing resistor.

2. The apparatus of claim 1 further comprising:
a third digital switch for connecting the analog to digital converter to a plurality of force sensing resistors configured to detect multiple simultaneous touches.
